(19) United States
(12) Patent Application Publication
(10) Pub. No.: US 2025/0033547 A1
(43) Pub. Date: Jan. 30, 2025

(54) VEHICLE STORAGE SYSTEM

(71) Applicant: Decked LLC, Ketchum, ID (US)

(72) Inventors: Spencer Robert Dahl, Sun Valley, ID (US); James Calvin Allan, Ketchum, ID (US); Shaun Christopher Muston, South Lyon, MI (US); Jordan Daniel Lanning, Boise, ID (US); Samuel Quintrell Wood, Ketchum, ID (US); William Banta, Ketchum, ID (US)

(21) Appl. No.: 18/358,298

(22) Filed: Jul. 25, 2023

(51) Int. Cl. B60P 1/00; B60R 9/06

(52) U.S. Cl. CPC B60P 1/003; B60R 9/065

(57) ABSTRACT

A vehicle storage system may include a deck configured to span substantially a total width of a vehicle bed, four support feet including two front support feet and two rear support feet, a center support extending in a longitudinal direction of the vehicle bed between the support feet and configured to support the deck, and a drawer assembly. The deck may include raised portions for coupling to an underside of an accessory case, and tie down attachment points that anchor materials to the deck, while transferring load and connecting the storage system to the truck bed. The drawer assembly may extend outward from the deck to allow full opening of the accessory case without removal of the accessory case from the drawer assembly.

### FIELD OF THE INVENTION

The present invention relates generally to a vehicle storage system, and a method of making such a vehicle storage system.

### BACKGROUND INFORMATION

Existing vehicle storage systems such as truck storage systems generally comprise a box frame or cabinet structure having a drawer that is placed within a vehicle bed such as a truck bed and secured to the truck bed via brackets and holes drilled in the truck bed. Such drawers generally do not extend sufficiently beyond the deck to allow for opening of, and convenient access to, accessory cases placed within the drawer, nor are they dimensioned to allow full utilization of the available storage space within the drawer. Further, the loading and/or hauling of materials on top of the storage systems is rendered more difficult and less reliable as the upper surface of the storage systems are not designed for preventing the slipping and/or sliding of such materials. In addition, storage compartments of existing vehicle storage systems lack versatility and are constrained to a limited number of well-defined storage materials or containers. Moreover, these storage systems are designed with a variety of parts that are independently necessary to account for performance requirements, such as heavy loads situated on the storage system, materials anchored to the storage system, and connecting the storage system to the truck bed, thereby adversely affecting both the overall storage system and the vehicle performance.

### SUMMARY

In accordance with an exemplary embodiment of the present invention, a truck storage system may include a deck configured to span substantially a total width of a truck bed, four support feet, each support foot situated at a respective corner of the truck bed and configured to support the deck, a center support extending in a longitudinal direction of the truck bed between the support feet and configured to support the deck, at least one drawer assembly situated between a front support foot of the four support feet and a rear support foot of the four support feet on a first side, and the center support on a second side, the drawer assembly configured to be slidable in the longitudinal direction of the truck bed, and at least one storage compartment situated between the at least one drawer assembly and a side of the truck bed, the at least one storage compartment may be structurally separate from the support feet.

The at least one storage compartment may be at least substantially waterproof, may include at least two storage compartments, a first of the two storage compartments may be situated adjacent the rear support foot and a second of the two storage compartments may be situated adjacent the front support foot on the first side of the deck, and may be fully removable

The truck storage system may further include at least one storage cover to cover the at least one storage compartment, the at least one storage cover may be approximately twice a length of a respective storage compartment.

The truck storage system may further include at least two tie down attachment members, each tie down attachment members, each tie down attachment member situated between the at least one drawer assembly and the side of the truck bed.

The truck storage system may further include at least two brackets, each bracket connecting a respective tie down attachment member to a channel extending in a longitudinal direction of the truck bed, each of the brackets configured to support a load on the deck, anchor cargo in place, and attach the storage system to the truck bed. Each of the at least two tie down attachment members may include an attachment ring configured to fold down into a recessed cavity of the deck and to rotate upward and swivel.

The storage system may be attached to the truck bed via a turnbuckle mechanism.

The at least one drawer assembly includes at least two drawer assemblies that are nestable for packaging, shipping and/or storage.

The at least one drawer assembly may have side walls that slope at an angle of at most 1 degree, and may be configured to extend outward of the deck by at least 75% of a length of the at least one drawer assembly.

The deck may have an upper surface which may have a raised pattern configured to engage a relief pattern on an underside of at least one accessory case to create a positive-fit connection between the deck and the at least one accessory case. The raised pattern may cover a majority of the upper surface of the deck.

The truck storage system may further include at least two tie down attachment members, each tie down attachment member situated between the at least one drawer assembly and the side of the truck bed, an area between the at least two tie down attachment members does not contain the raised pattern.

The deck may include two deck halves configured to interleave with each other above the center support, and the front support foot and the rear support foot may be dimensionally different.

The truck storage system may further include at least one closeout member which may be configured to provide stability to the deck and to prevent an ingress of water into the at least one drawer assembly.

In accordance with a second exemplary embodiment of the present invention, the truck storage system may include a deck configured to span substantially a total width of a truck bed, four support feet, each support foot situated at a respective corner of the truck bed and configured to support the deck, a center support extending in a longitudinal direction of the truck bed between the support feet and configured to support the deck, at least one drawer assembly situated between a) a front support foot and a rear support foot on one side, and b) the center support on an other side, the drawer assembly configured to be slidable in the longitudinal direction of the truck bed, and at least one storage compartment, the at least one storage compartment situated between the at least one drawer assembly and a side of the truck bed, the at least one storage compartment is situated adjacent to a respective rear support foot

In accordance with a third exemplary embodiment of the present invention, the truck storage system may include a deck configured to span substantially a total width of a truck bed, four support feet, each support foot situated at a respective corner of the truck bed and configured to support the deck, a center support extending in a longitudinal direction of the truck bed between the support feet and configured to support the deck, at least one drawer assembly situated between a) a front support foot and a rear support foot on one side, and b) the center support on an other side, the drawer assembly configured to be slidable in the longitudinal direction of the truck bed, at least one storage compartment, the at least one storage compartment situated between the at least one drawer assembly and a side of the truck bed, the at least one storage compartment may be structurally separate from the support feet, at least one tie down attachment member, the tie down attachment member situated between the at least one drawer assembly and the side of the truck bed, and at least one bracket, the at least one bracket connecting the tie down attachment member to a channel extending in a longitudinal direction of the truck bed.

Example embodiments of the present invention are described in more detail below with reference to the appended Figures.

### BRIEF DESCRIPTION OF THE DRAWINGS

FIG. 1 shows a top perspective view of a first exemplary embodiment of a truck storage system according to the present invention.

FIG. 2 shows a partially exploded view of the first exemplary embodiment of a truck storage system according to the present invention.

FIGS. 3A to 3E show top perspective, bottom perspective, top, bottom and lateral side views, respectively, of a left deck half or a right deck half of a truck storage system according to the present invention.

FIGS. 4A to 4D show top perspective, top, rear and left side views, respectively, of a center support assembly of a truck storage system according to the present invention.

FIG. 5 shows a top perspective view of another exemplary embodiment of a center support assembly of a truck storage system according to the present invention.

FIGS. 6A to 6D show top perspective, top, front/rear and lateral side views, respectively, of a rear support foot of a truck storage system according to the present invention. Foot A is driver-rear w/axle and pass-front no axle. Foot B is driver-front no axle and pass-rear with axle.

FIGS. 7A to 7D show top perspective, top, front/rear and lateral side views, respectively, of a front support foot assembly of a truck storage system according to the present invention. Foot A is driver-rear w/axle and pass-front no axle. Foot B is driver-front no axle and pass-rear with axle.

FIGS. 8A to 8D show top perspective, top, front/rear and lateral side views, respectively, of a storage container assembly of a truck storage system according to the present invention.

FIGS. 9A to 9F show top perspective, bottom perspective, top, bottom, front/rear and lateral side views, respectively, of a storage container cover of a truck storage system according to the present invention.

FIGS. 10A to 10D show top perspective, top, front/rear and lateral side views, respectively, of a tie down member of a truck storage system according to the present invention.

FIGS. 11A to 11D show top perspective, top, front/rear and lateral side views, respectively, of a closeout member of a truck storage system according to the present invention.

FIGS. 12A to 12C show top perspective, front/rear and lateral side views, respectively, of a guide channel of a truck storage system according to the present invention.

FIGS. 13A to 13F show top perspective, top, rear, lateral side, cross-sectional and close-up cross-sectional views, respectively, of a drawer assembly of a truck storage system according to the present invention. FIG. 13E is a cross-sectional view along line A-A shown in FIG. 13D, and FIG. 13F is a close-up cross-sectional view of the circled portion shown in FIG. 13E.

FIGS. 14A to 14D show top perspective, rear, front and lateral side views, respectively, of a lock of a truck storage system according to the present invention.

FIGS. 15A to 15D show top perspective, top, left side rear and right side rear views, respectively, of a drawer wheel bracket assembly of a truck storage system according to the present invention.

FIGS. 16A to 16D show top perspective, top, front/rear and lateral side views, respectively, of a drawer divider of a truck storage system according to the present invention.

### DETAILED DESCRIPTION

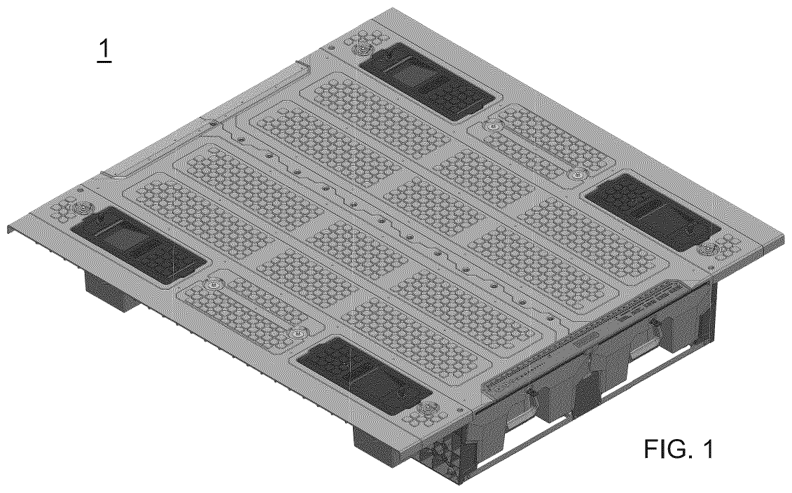

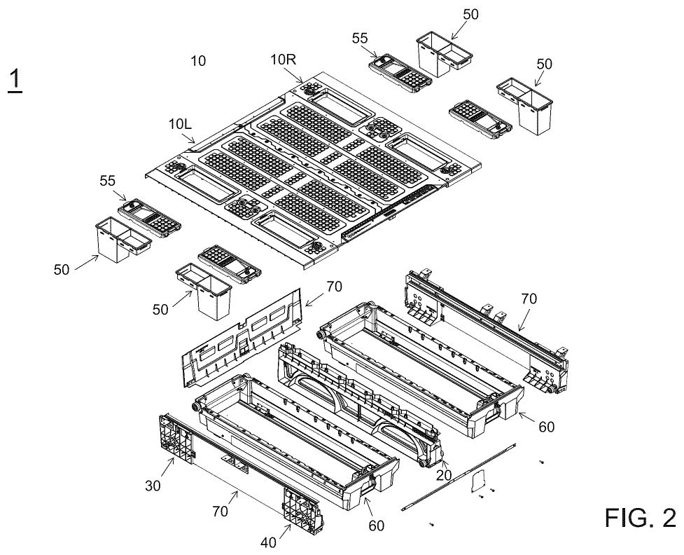

FIG. 1 shows a top perspective view and FIG. 2 shows a partially exploded view of a first exemplary embodiment of a truck storage system 1 according to the present invention. As shown in FIGS. 1 and 2, the truck storage system 1 may comprise a deck 10 including a left deck half 10L and a right deck half 10R, a center support assembly 20, front support feet 30, rear support feet 40, storage compartments 50, storage compartment covers 55, drawer assemblies 60, and closeouts 70, all of which will be described further herein. The truck storage system 1 may be sized to fit both long and short truck beds, and may cover substantially the full width of the truck bed, as shown in FIG. 1, for example.

As used herein, the terms “front,” “rear,” “left side,” and “right side” refer to directions with reference to a vehicle, e.g., a pickup truck, in which the truck storage system may be installed. For example, the term “front” refers to a forward-moving direction of the vehicle, the term “rear” refers to a rearward-moving direction of the vehicle, the term “left side” refers to a driver side of the vehicle (as commonly used in the U.S.), and the term “right side” refers to a passenger side of the vehicle (as commonly used in the U.S.).

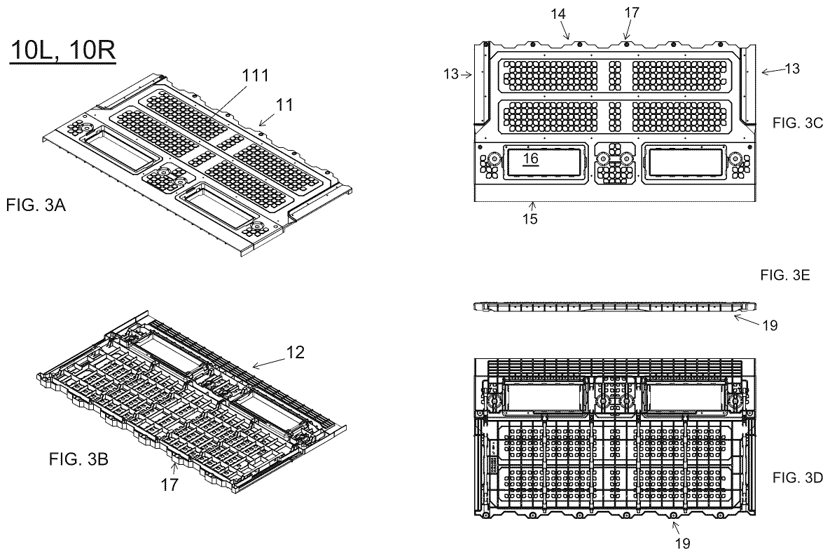

FIGS. 3A to 3E show various views of a left deck half 10L or a right deck half 10R of a truck storage system 1 according to the present invention.

The left and right deck halves 10L, 10R may include an upper surface 11, a lower surface 12, front and rear edges 13, inner side edge 14, and lateral side edge 15. The deck halves 10L, 10R may be made of high density polyethylene, other plastics, metals, or combinations thereof, for example. The upper surface 11 may include one or more surface treatments which may provide traction to prevent slipping and/or sliding of materials, such as, for example, one or more accessory cases placed upon the upper surface 11. For example, the upper surface 11 may include a raised portion 111 in one or more distinct areas of the upper surface 11. The raised portion 111 may be, for example, in the form of a pattern or series of uniformly spaced protrusions or bumps.

The raised portion 111 may correspond to an underside of one or more accessory cases having surfaces with one or more reliefs or grooves or holes. This correspondence may create a positive-fit connection between the deck 10 and the one or more accessory cases. The perimeter of at least sections of the raised portions 111 may enclose respective reliefs or grooves or holes of the one or more accessory cases. The raised portions 111 may thereby be adapted to engage with the corresponding or complimentary reliefs, holes, or grooves of the one or more accessory cases. The depth and shape of each relief, hole, or groove may correspond to a depth and shape of the protrusions or bumps such that they have corresponding profiles. Moreover, the distribution of the raised portions 111 may be selected based on the distribution of the reliefs or vice versa. The upper surface 11 of the deck 10 may thereby prevent or reduce a lateral displacement of the accessory case with respect to the deck 10. The reliefs on the underside of the accessory case may guide the placement and/or reception and/or attachment of the accessory case to the upper surface 11 of the deck 10, and thereby prevent the slipping and/or sliding of and/or disengagement of the accessory case. In an alternative embodiment, other mechanisms for preventing the slipping and/or sliding and/or disengagement of the accessory case may be employed such that a connection and/or friction between the accessory case and the upper surface 11 of the deck 10 would secure and/or stabilize the accessory case to the deck 10.

As shown in FIG. 1, the deck may include the raised portions 111 in different areas along the upper surface 11.

For example, the deck may include raised portions 111 throughout the upper surface 11 or only over a majority of the upper surface 11 of each deck panel 10L, 10R. In an example embodiment, the area above the center support assembly 20 may be generally flat without containing any raised portions 111. This may be beneficial so that an accessory case placed upon a specific deck half, e.g. the left deck half 10L does not inadvertently or unexpectedly travel to the other deck half, e.g., the right deck half 10R in response to a movement of the vehicle. Alternatively or additionally, an area adjacent to the tie-downs 211, discussed below, may be generally flat without containing raised portions 111. This may be beneficial so that items may be conveniently and/or efficiently mounted via, for example, rails at or near a location of a tie-down 211.

Different areas of the upper surface 11 may include different patterns of raised portions 111 to accommodate different patterns of reliefs of, for example, multiple accessory cases. For example, one or more areas along upper surface 11 may have raised portions 111 that are closer to each other or have wider portions, while other areas along upper surface 11 may have raised portions 111 that are farther apart or have narrower portions. The raised portions 111 may allow for various orientations or placements of one or more accessory cases on top of the deck 10.

Additionally, the upper surface 11 may include mounts, tracks, guides or rails for securing materials placed on the upper surface 11, and/or may include various functional and/or decorative indicia or surface treatments, such as, for example, embossing, debossing, texturing (e.g., graining), engraving, printing, etc.

The deck halves 10L, 10R may include a plurality of reinforcement beams 19, as shown in FIGS. 3B, 3D, and 3E, for example, that traverse the deck halves 10L, 10R transversely from the inner side edge 14 to the lateral side edge 15. The reinforcement beams 19 may be made of high density polyethylene, other plastics, metals, or combinations thereof, for example, and may provide sufficient stiffness and support for the deck halves 10L, 10R and materials loaded thereon. The reinforcement beams 19 may have a cross-section that is round, square, rectangle, I-beam, L-beam, and/or may taper. The reinforcement beams 19 may be made of a single part or multiple parts attached together.

The inner side edges 14 of the deck halves 10L, 10R may include a meandering profile that is identical for each deck half 10L, 10R, and is configured such that each of the left and right deck halves 10L, 10R may be made, at least initially, in the same shape and/or by using a single mold, i.e., non-handed deck halves. That is, the right deck half 10R is rotated 180 degrees from a position of the left deck half 10L, such that the inner side edges 14 of the deck halves 10L, 10R mate without gaps, thereby forming the deck 10.

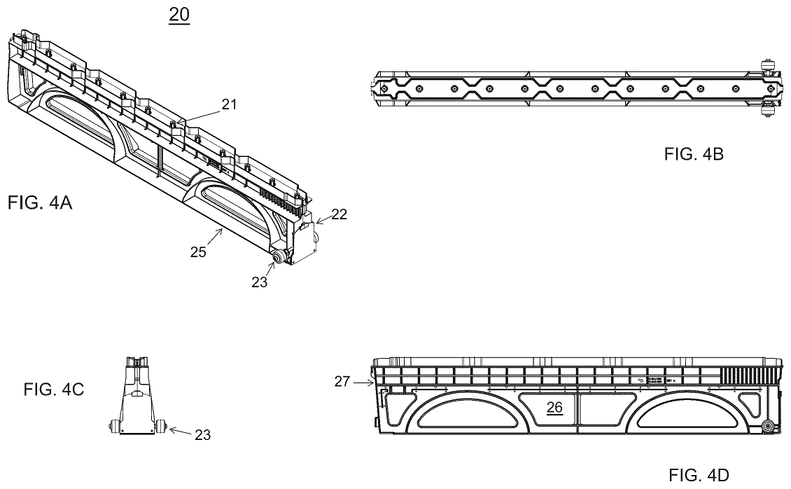

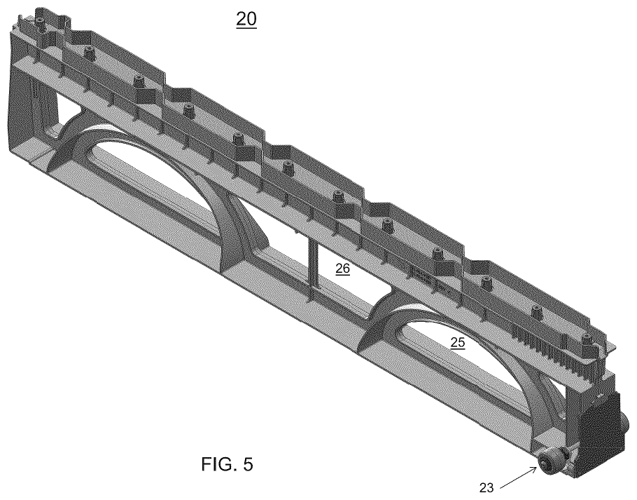

The inner side edges 14 of the deck halves 10L, 10R may also include holes 17 for receiving projections 21 of a center support assembly 20, as shown in FIGS. 4A to 5, for example. The holes 17 may be countersunk on the lower surface 12 of the deck halves 10L, 10R in order to receive the projections 21 of the center support assembly 20. Additionally, fasteners or adhesives may be inserted in the holes 17 to secure the deck halves 10L, 10R to the center support assembly 20. In addition, the interface of the inner side edges 14 of the deck halves 10L, 10R may be configured to prevent the ingress of water and/or divert such water away from the drawer assemblies 60 and down toward the truck bed, and/or the deck half geometry may be configured to accept/secure gaskets that further prevent ingress.

The lateral side edges 15 of the deck halves 10L, 10R may be processed to match the sidewall profiles of the truck bed in which the truck storage system 1 is to be installed. For example, the lateral side edges 15 of each deck half 10L, 10R may be cut, machined, laser cut, waterjet cut, or otherwise modified to precisely match the sidewall profiles of the truck bed, which sidewall profiles differ between various truck manufacturers and models, and may also differ between left and right sides on a single truck model.

The deck halves 10L, 10R may also include storage container openings 16 that mate with the front and rear storage containers 50. Fasteners and/or adhesives may be used to secure the deck halves 10L, 10R to the front and rear storage containers 50. Between the storage containers 50 and deck panels 10L, 10R, geometry may exist to further route water such as, for example, gaskets, spouts, drill edges, to prevent ingress.

FIGS. 4A to 5 show various views of a center support assembly 20 of a truck storage system 1 according to the present invention. The center support assembly 20 may be made of high density polyethylene, other plastics, metals, combinations thereof, and/or composites such as those produced via a pultrusion, e.g. combination of resin and fiberglass. As described, the center support assembly 20 may include projections 21 to mate with the holes 17 on the lower surface 12 of the deck halves 10L, 10R. In addition, the center support assembly 20 may include integral drawer wheel channels 22 for guiding wheels 63 provided on a drawer assembly 60, as well as wheels 23, to facilitate sliding of the drawer assemblies 60. Alternatively, the center support assembly 20 may include, for example, surfaces sliding adjacent to each other, such as plastic linear bearings to allow sliding of the drawer assemblies 60.

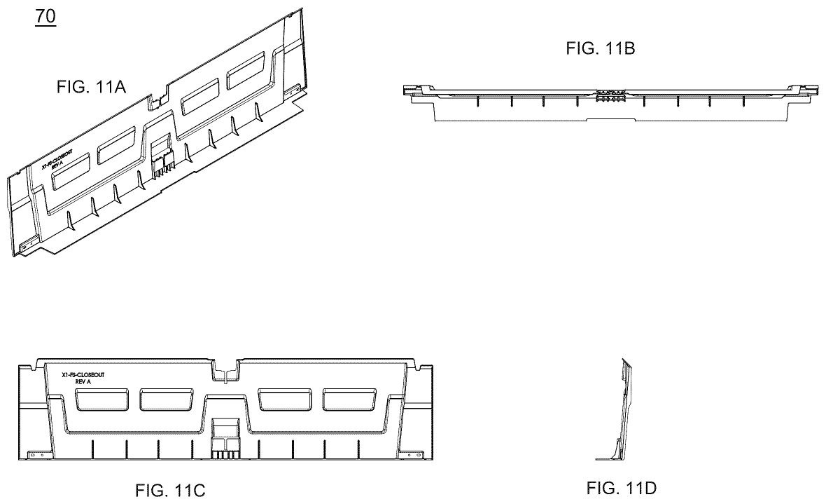

The integral drawer wheel channels 22 may include at least one self-centering formation 27 that is configured to maintain wheels 63 provided on a drawer assembly 60 that roll within the integral drawer wheel channels 22 in an optimal position, e.g., both vertical position, as well as horizontal or lateral position, for smoothly opening/closing a drawer assembly 60. Furthermore, as shown in FIGS. 4A to 5, the center support assembly 20 may also include arches 25, reinforcement ribs, and weight reduction holes 26 to simultaneously reduce weight of the center support assembly 20 while maintaining the strength of the truck storage system 1 to support the weight of materials placed thereon. Furthermore, as shown in FIGS. 11A-11D, the truck storage system 1 may also include side and/or front closeouts 70, and webbed walls in addition to the arches 25, reinforcement ribs, and weight reduction holes 26 of the center support assembly 20 to simultaneously reduce weight of the center support assembly 20 while maintaining the strength of the truck storage system 1 to support the weight of materials placed thereon, as well as to provide stability and to prevent the ingress of water and/or divert such water away from the drawer assemblies 60.

The center support assembly 20 may be configured as a load rest on the truck bed, such that no physical interconnections or attachments exist between the truck bed and the center support assembly 20. That is, the center support assembly 20 may simply rest on the truck bed due to gravity and/or the weight of any materials placed on the deck 10. Accordingly, the center support assembly 20 may be installed in the truck bed without requiring structural modification of the truck bed, such as for example, drilling holes in or bending/deforming the truck bed. In addition, the center support assembly 20 may be designed with a flat, broad bottom to effectively provide stability and support across undulating surfaces.

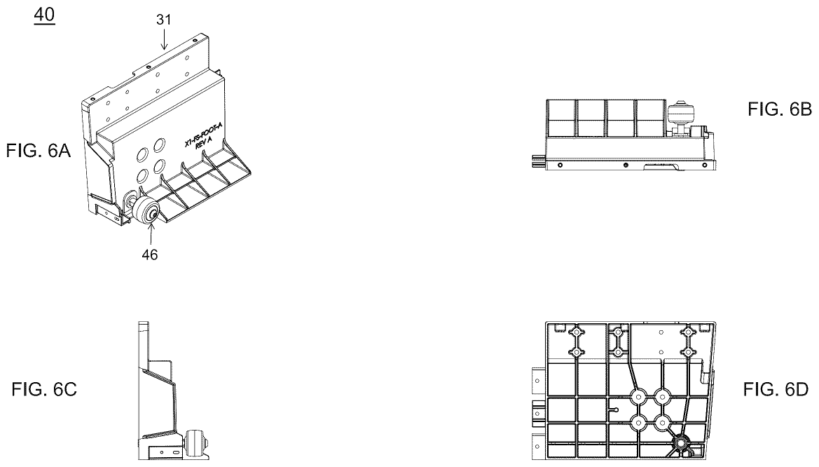

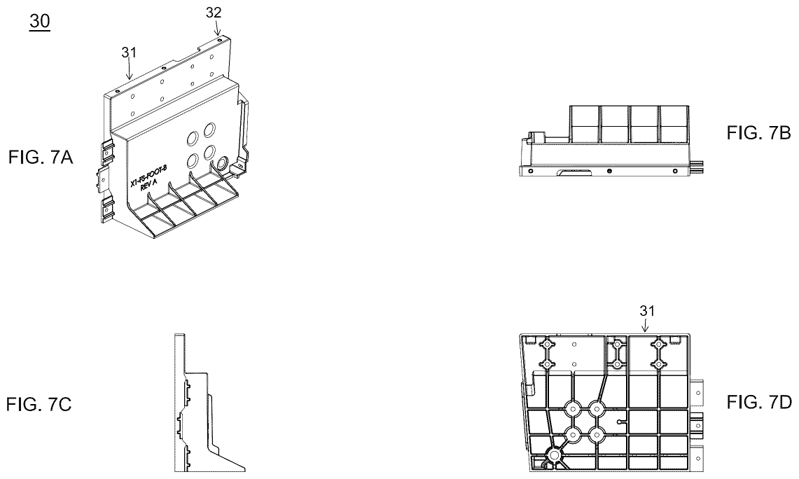

FIGS. 6A to 6D and 7A to 7D show various views of a support foot 30, 40 of a truck storage system according to the present invention. The foot may be a driver-rear w/axle and pass-front no axle, or the foot may be a driver-front no axle and pass-rear with axle.

One front support foot 30 may be configured to be attached to the deck halves 10L, 10R in each of the front, driver side corner and the front, passenger side corner of the truck storage system 1, and one rear support foot assembly 40 may be configured to be attached to the deck halves 10L, 10R in each of the rear, driver side corner and the rear, passenger side corner of the truck storage system 1, as shown in FIG. 2, for example. The front and rear support feet 30, 40 may be made of high density polyethylene, other plastics, metals, combinations thereof, and/or may include composites such as fiberglass, for example. The front and rear support feet 30, 40 may include an upper surface 31 having holes 32 that align with a surface above for attachment between the deck 10 and the front and rear support feet 30, 40. For example, fasteners and/or adhesives may be inserted through holes 32, to secure the deck 10 to the front and rear support feet 30, 40. The front and rear support feet 30, 40 may also include a lower surface 33 that rests on the truck bed. Geometry of the lower surface 33 may be maximized in, for example, dimensions, geometry, and texture, to provide maximal stability with the truck bed surface.

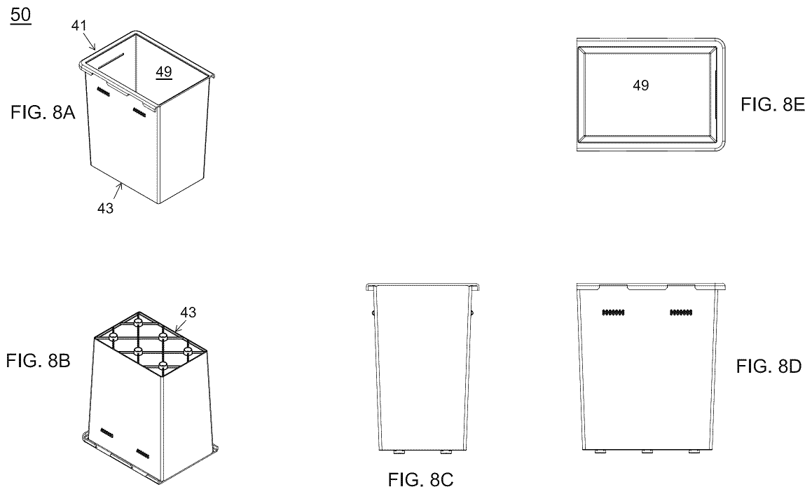

FIGS. 8A to 8E show various views of a storage container 50 of a truck storage system according to the present invention. Between the upper surface 41 and lower surface 43, the storage container 50 may define a compartment 49 in which beverages, tools, fasteners or any other items may be placed.

The storage compartment 50 may be structurally separate from the support feet 30, 40 such that they are at least situated in spaced relation along at least a width direction of the vehicle bed. This provides the advantage that the storage compartment 50 and the support feet 30, 40 are each essentially independent units which allows for a simple and economical manufacture and use of each structure. In addition, each individual structure can be separately removed and replaced without adversely affecting the other structure. For example, the storage compartment 50 may be removed and replaced without affecting the support feet 30, 40 which may be currently supporting the deck 10.

The compartment 49 may be or may contain one or more stash bins, buckets, and/or bags which are configured for storage of items. The stash bins, buckets, and/or bags are configured to fit within the compartment 49, which is sized to receive the one or more stash bins, buckets, and/or bags by a loose fit, press fit, snap fit, and twist fit connection. The stash bins, buckets, and/or bags may be fully or partially removable from within the compartment 49. The stash bins, buckets, and/or bags may be situated within the compartments 49 such that an upper portion of the stash bins, buckets, and/or bags spans a horizontal area of the deck. For example, an upper rim of the stash bins, buckets, and/or bags may be configured so that they outwardly extend and/or hang on a lip of the deck 10. The one or more stash bins, buckets, and/or bags may be the same size or have different sizes to allow for convenient storage and removal of different sized items within the one or more stash bins, buckets, and/or bags.

The compartment 49 may be fitted with one or more removable covers or lids 55, as shown in FIGS. 8A to 8F to weatherproof the items within the compartment 49 when the lid 55 is in a closed position. Specifically, when the lid 55 is closed, it may seal any gaps that exist to thereby weatherproof the compartment 49. Further, the upper surface 41 may include drain holes (not shown), e.g., forward and rearward drain holes, to direct water or other substances away from the compartment 49 and down toward the truck bed. The covers or lids 55 may be fully removable or may be movably hinged and pivot between fully closed and opened positions.

The various compartments 49, e.g., the rear or front side compartments may be of different sizes. For example, the compartments adjacent to the rear support feet 40 may be larger than the compartments 49 adjacent to the front support feet 30, thus allowing for a larger area of storage in compartments adjacent to the rear support feet 40 relative to compartments adjacent to the front support feet 30. In an example embodiment, there may be two rear stash bins, which may be of different sizes, for example, a smaller and larger size within the rear storage container 50, while there may be one front stash bin within the front storage container 50. Each storage container 50 may be sealed with a lid 55 that corresponds to the size and shape of the respective compartment 49. Thus, for example, the compartment lid 55 for the rear storage container 50 may be larger than the compartment lid 55 for the front storage container 50. The compartments 49 may be secured to the lids 55 via a lock member to prevent unauthorized entry.

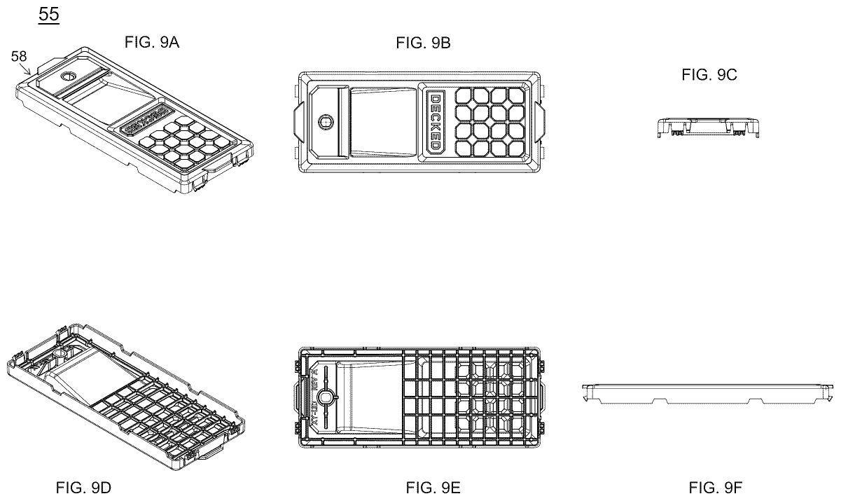

FIGS. 9A to 9F show various views of stash bin lids/covers 55 of a truck storage system 1 according to the present invention. The cover 55 may be made of high density polyethylene, other plastics, metals, or combinations thereof, for example. The cover 55 may be configured to fit snugly, e.g., by friction fit or snap fit, within openings 16 of the deck halves 10L, 10R, and to mate and/or substantially seal with upper surfaces 41 of the front and rear stash bins 50. A finger access lip 59 may be provided on an edge of cover 55, and a corresponding finger access recess may be provided on deck halves 10L, 10R to facilitate removal of the covers 55. An upper surface of cover 55 may include various functional and/or decorative indicia 51 or other surface treatment formed by, for example, embossing, debossing, texturing (e.g., graining), engraving, printing, etc. For example, the surface treatment of the upper surface of cover 55 may provide traction to prevent slipping and/or sliding of materials placed on the upper surface. A lower surface of cover 55 may include cup holders 52 and/or other areas 53 for the placement of cups, tools, fasteners or any other objects, when the cover 55 is removed from opening 16 or when the cover 55 is placed upside down within opening 16.

In addition, the front and rear storage compartments 50 may include substantially spherical, semispherical or rounded attachment points. Preferably, the attachment points of the front and rear storage compartments 50 may be secured to existing brackets, holes or tie-down points in the truck bed via a turnbuckle assembly 411. The turnbuckle assembly 411 may include a hook on both ends and a middle portion that twists for tightening and tensioning. One hook associated with the turnbuckle 411 may be positioned around a bracket. The turnbuckle assembly 411 may be configured to hook around an attachment point in order to secure the turnbuckle assembly 411 at variously placed existing brackets, holes or tie-down points of the truck bed. Accordingly, the storage compartments 50 may be installed in the truck bed without requiring structural modification of the truck bed, such as for example, drilling holes in or bending/deforming the truck bed, since the turnbuckle assembly 411 may be attached to existing brackets, holes or tie-down points of the truck bed. Additionally, further brackets may be installed in the truck bed at existing holes or tie-down points to facilitate the use of the turnbuckle assembly 411 for securing the storage compartments 50. The turnbuckle assembly 411 may be made of high density polyethylene, other plastics, metals, or combinations thereof, for example.

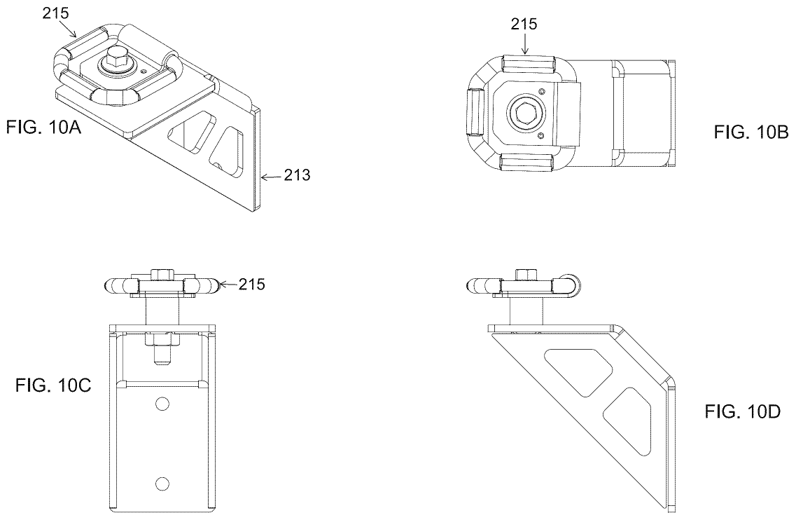

Each of the deck halves 10L, 10R may include a plurality of tie-downs 211, as shown in FIGS. 10A-10D, for example, that are located at intervals along the upper surface 11 of the deck and traverse the upper surface 11 of the deck halves 10L, 10R laterally from adjacent to the rear support feet 30 to the front support feet 40. For example, each of the deck halves 10L, 10R may include four tie-down holes and underlying brackets 213 running up each side. The tie-downs 211 may be equally spaced apart along the deck 10 extending laterally from one end of the deck 10 to the other end of the deck 10. The tie-downs 211 may include a hook, for example, in the form of a D-ring 215, which may be disposed above the surface of the deck 10 when in use and which may serve to anchor and/or secure cargo. The D-ring 215 may be recessed within a pocket of the deck 10 when not in use to prevent, for example, snagging or accidental catching of accessories placed upon the deck 10. The lower portions of the tie-downs 211 may be embedded within the deck 10.

The brackets 213 may be welded steel brackets that are fastened to a respective tie down 211 and bolted to the C channel to transfer load to the truck bed. The brackets 213 may thereby serve at least three independent and simultaneous functions: to support load from above, act as a tie-down anchor for items placed above using, for example, a D-ring 215, and to assist with the deck 10 attachment to the truck bed.

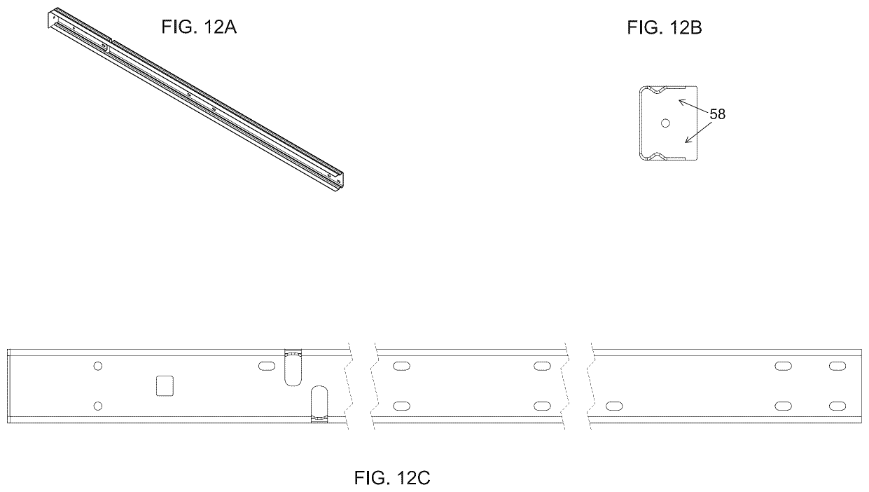

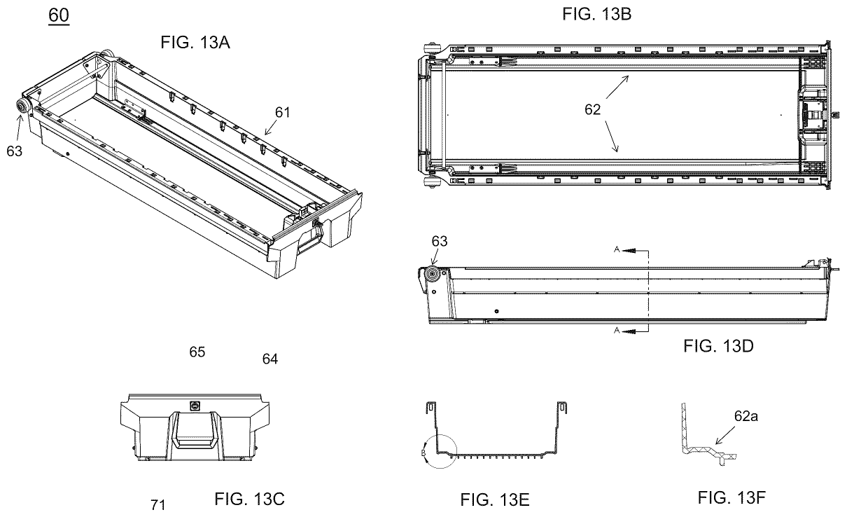

Further, the front and rear support feet 30, 40 may include at least one guide channel surface on which a guide channel 57, as shown in FIGS. 12A to 12C, for example, may rest and/or be secured. The guide channel 57 may be made of high density polyethylene, other plastics, metals, or combinations thereof, for example. The guide channel 57 may be attached to the front and rear support feet 30, 40 by fasteners and/or adhesives, and extend in a front-to-rear direction between front and rear support feet 30, 40 provided on a same side (i.e., driver side or passenger side) of the truck storage system 1, as shown in FIG. 2, for example. The guide channel 57 may include at least one self-centering formation 58 that is configured to maintain wheels 63 provided on a drawer assembly 60 that roll within the guide channel 57 in an optimal position, e.g., both vertical position, as well as horizontal or lateral position, for smoothly opening/closing a drawer assembly 60, as shown in FIGS. 13A to 13F, for example.

The rear support foot assembly 40 may further include a wheel 46 that may be provided at a rearward lower portion of the rear support foot assembly 40. That is, for a rear support foot assembly 40 provided at the rear, driver side corner of the truck storage system 1, the wheel is attached at one location, whereas for a rear support foot assembly 40 provided at the rear, passenger side corner (i.e., rotated 180 degrees from the rear, driver side corner position) of the truck storage system 1, the wheel 46 may be attached to a different location. The wheels 46 of the rear support foot assemblies 40 cooperate with the wheels 23 of the center support assembly 20 to facilitate sliding of the drawer assemblies 60.

FIGS. 13A to 13F show various views of a drawer assembly 60 of a truck storage system 1 according to the present invention. The drawer assembly 60 may be made of high density polyethylene, other plastics, metals, or combinations thereof, for example. Each drawer assembly 60 may be rated to carry a payload of about 200 lbs, for example.

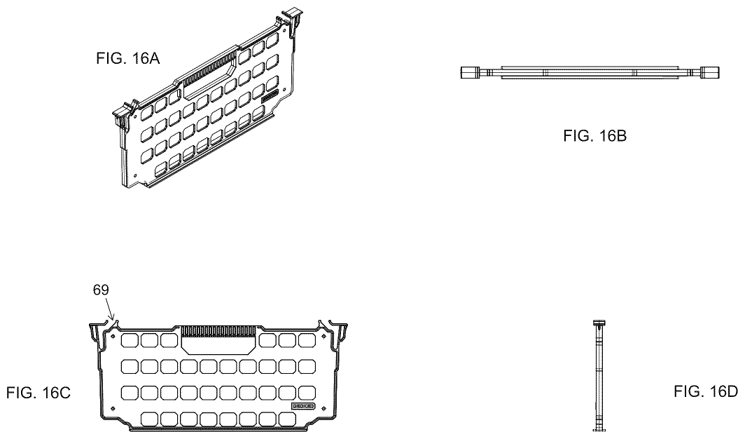

The drawer assembly 60 may include a drawer 61, integral wheel channels 62, wheels 63, wheel bracket assemblies 66, integral handle 64, lock 65 and latch assembly 71. The drawer 61 may be configured to receive materials therein, and may include notches or other formations to transversely receive drawer dividers 68, as shown in FIGS. 16A to 16D, for example, and the drawer 61 may receive a mat along its inner bottom surface. The drawer dividers 68 may include notches or other formations 69 to allow the placement of longer items within drawers 61 when using dividers 68 or to facilitate the use of ropes, cords or other items for tying down and/or securing items within the drawers 61. Alternatively, drawer dividers that extend in a front-to-rear direction of the drawer 61 may also be provided. The drawer dividers 68 may be made of plastic, steel, foam, or any other suitable combination and may be clipped to an underside of a rail of the drawer 61.

In addition, the integral handle 64 of drawer 61 may be initially molded into the drawer 61 and facilitate opening, closing and/or grasping of the drawer assemblies 60. An integral handle may also be provided at opposite end of drawer 61 to facilitate grasping of the drawer assemblies 60, for example, when removed from the truck storage system 1. Further, the drawer 61 may be configured to allow nesting of multiple drawers 61 within each other for packaging, shipping and/or storage by appropriate design of, for example, the sidewalls, integral wheel channels 62 and integral handle 64 of the drawer 61.

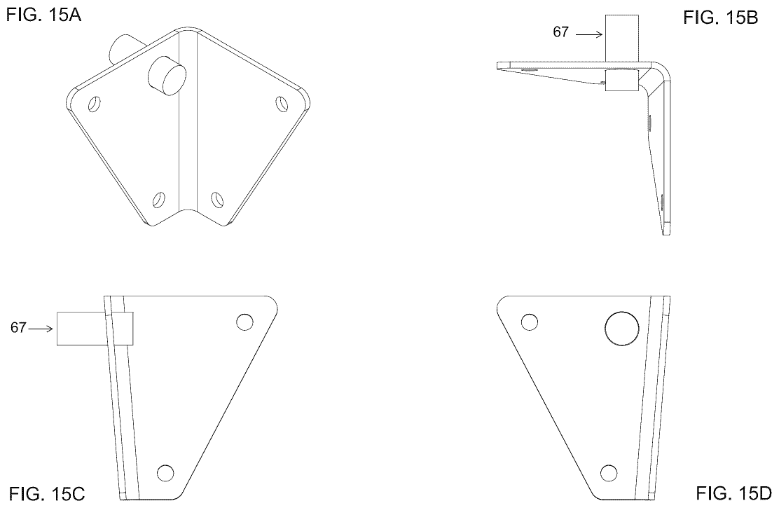

The integral wheel channels 62 may receive the wheels 23 of the center support assembly 20 and the wheels 46 of the rear support foot assembly 40, and the wheels 63 may roll within integral drawer wheel channels 22 of center support assembly 20 and guide channel 57 secured to front and rear support feet 30, 40 to facilitate sliding of the drawer assemblies 60. The integral wheel channels 62 of the drawer assemblies 60, may include at least one self-centering formation 62a that is configured to maintain the drawer assemblies 60 in an optimal position, e.g., both vertical position, as well as horizontal or lateral position, for smooth opening/closing. The integral wheel channels 62 may end at a position short of the forward end of the drawer 61, such that the ends of the integral wheel channels 62 act as integral stops to prevent further opening or falling out of the drawer assemblies 60. If the user desires to remove the drawer assemblies 60, this can be effected by removing the wheels 23, 46 and then removing the drawer assemblies 60. The wheels 63 may be attached to the drawer 61 by wheel bracket assemblies 66 having wheel shafts 67, as shown in FIGS. 15A to 15D, for example. The wheel bracket assembly 66 may be a single, non-handed design that can be used for both wheels 63 of the drawer 61 by using one wheel shaft 67 in one installation position and the other wheel shaft 67 in the other installation position, while one or the other wheel shaft 67 remains unused in each position and extends through the forward end of the drawer 61.

The side walls of drawer 61 may slope at an angle of at most 1 degree between an upper surface of the drawer and a lower surface of the drawer. In an example embodiment, the side walls of drawer 61 may slope at an angle of at most degree. These reduced slopes result in an increased drawer volume and may allow an essentially cubed shaped accessory case to fit within, and make full use of the interior space of the drawer 61. In addition, the reduced slope may allow for secure and modular stacking of multiple accessory cases.

The front of the drawer 61 may include, for example, a facade near the tail gate which may disrupt potential ingress of dust/water/debris into the drawers 61. In addition, the top of the drawer 61 may have a facade that includes a weather-strip to further prevent ingress.

When the drawer 61 is extended out from the deck to a distance greater than a length of an accessory case, the lid of the accessory case may be rotated upward at least 100 degrees from a closed position while still situated within the interior space of the drawer 61. The lid may be rotated upward at a side opposite the hinged side to thereby gain access to the space within the accessory case.

Drawer 61 may contain metal brackets, such as, for example, L brackets or corner braces which are disposed at an approximate midportion of the drawer 61, such as where wheel stops on the underside of the drawer 61 may be situated, and bolted securely to the bottom and side walls of the drawer 61. The brackets may serve to provide additional strength and reinforcement to the drawer 61, without inhibiting access thereto, due to their lower profile designs. The brackets may also allow the drawer 61 to be extended further out from a stowed position from within the deck, thereby affording improved access to a greater portion of the interior volume of the drawer 61. At full extension, the drawer 61 may be capable of withstanding 200 lbs of weight. In an example embodiment, for a long truck bed (approximately 6.5 feet), the drawer 61, which may be 72 inches in length, may be extended outward 56 inches beyond the deck. In a short truck bed (approximately 5.5 feet), the drawer 61, which may be 62 inches in length, may be extended outward 46 inches beyond the deck. In addition, each side of drawer 61 may include lateral steel tubes, which may be installed after molding, for increasing the strength of drawer 61.

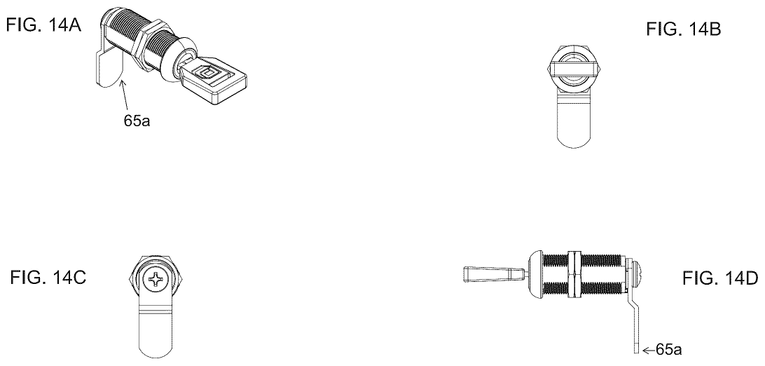

Lock 65 may allow locking of the drawer assembly 60 in the fully closed position. The lock 65, as shown in FIGS. 14A to 14D, for example, may include a locking cam 65a that can rotate between an open position and a closed position. In an open position, the locking cam 65a allows the drawer assembly 60 to be pulled out of the truck storage system 1. In the closed position, the locking cam 65a may cooperate with structure on the lower surface 12 of the deck halves 10L, 10R to prevent pulling out of the drawer assembly 60. For example, the locking cam 65a may engage with a reinforcement beam 19 that at least partially protrudes from the lower surface 12 of the deck halves 10L, 10R, thereby not requiring any additional structural features to be molded into the deck halves 10L, 10R to provide the locking function. Alternatively, the locking cam 65a may engage with other structure on the lower surface 12 of the deck halves 10L, 10R.

All components of the truck storage system 1 may be made in long and short versions that correspond to long truck bed designs of approximately 5.5-6.5 feet and short truck bed designs of approximately 4.5-5.5 feet. For example, components such as the deck halves 10L, 10R, center support assembly 20, guide channels 57, drawer assemblies 60, and a trim piece may be manufactured in long and short versions. Only one set of tooling may be needed for these components, in which tool inserts may be inserted/removed for manufacturing long vs. short versions. Thus, long and short variations of the truck storage system 1 may be economically manufactured with one set of tooling. Moreover, the non-handedness of many of the components of the truck storage system 1, such as for example, the deck halves 10L, 10R, guide channel 47, and drawer assemblies 60, may further allow for economical manufacture of the storage system 1.

Furthermore, all components of the truck storage system 1 may be designed to fit within myriad truck bed designs of truck manufacturers. For example, the truck storage system 1 may be designed to accommodate seventeen of the eighteen series of full-sized pickup trucks sold in the U.S. since 2000. For example, lateral side edges 15 of the deck halves 10L, 10R may be processed to fit within any one of the myriad truck bed designs. In addition, the center support assembly 20 may be designed to rest securely within any one of the myriad truck bed designs. In this respect, truck beds generally have an undulating surface from the driver side to the passenger side of the truck bed, e.g., an alternating series of upstanding and downstanding beads. As a result, the width of the lower surface of the center support assembly 20 may be designed to rest securely on the variously designed undulating surfaces of any one of the myriad truck bed designs, e.g., on one upstanding bead, or on two upstanding beads and straddling one downstanding bead. Similarly, the front and rear support feet 30, 40 may be designed to rest securely on the variously designed undulating surfaces of any one of the myriad truck bed designs. Further, the front and rear support feet 30, 40 may be designed to interface with existing holes, brackets or tie-down points of any one of the myriad truck bed designs.

In addition, the bottom surface of the drawers 61 may be designed with a notch, a raised surface and/or a sloped surface configured to provide clearance to a lowered tailgate. Truck bed and tailgate designs of various truck manufacturers provide different angles of inclination, i.e., tailgate ramp angle, of the lowered tailgate with respect to the plane of the bottom surface of the truck bed, and the largest of the different angles of inclination is approximately 2.5 degrees. Thus, in order to provide clearance for fully opening the drawer assemblies 60, a notch, a raised surface and/or a sloped surface may be provided on the bottom surface of the drawer 61, such that a single drawer design can be used in any one of myriad truck bed designs. Accordingly, a single design of truck storage system 1 can be used by owners of any one of the myriad truck bed designs of truck manufacturers. In addition, the bottom surface of the drawers 61 may included geometry (e.g. a dimple or boss) to indicate optimal location of a drain. The drain feature may be formed by the user drilling through the drawer surface.

As a result, if an owner has installed the truck storage system 1 in an old truck, but then sells the old truck and purchases a new, different truck, the owner can simply remove the existing truck storage system 1 from the old truck, purchase only new deck halves 10L, 10R having lateral side edges 15 processed to fit within the new truck, and reinstall all other components of the existing truck storage system 1 in the new truck with the new deck halves 10L, 10R.

All components of the truck storage system 1 may be configured to nest within each other for packaging, shipping and/or storage, for example. As described herein, the drawer assemblies 60 may nest within each other. In addition, components such as front support feet 30, rear support feet 40, storage compartment covers 55, lock 65, drawer dividers 68, latch assembly 71, trays, stash bins 50, wheels, fasteners, brackets, and/or adhesives, and any other small parts may be placed within nested drawer assemblies 60. The remaining components, such as the deck halves 10L, 10R, center support assembly 20, guide channels 57, and any other large parts such as accessory cases may be packaged together with the nested drawer assemblies 60 or other components. Alternatively, the deck halves 10L, 10R may be packaged and/or shipped separately from the remaining components.

All components of the truck storage system 1 may be made of high density polyethylene, other plastics, metals, or combinations thereof, for example. Since the storage system 1 is to be installed in truck beds that are typically exposed to the environment and may encounter heavy loads and rough use, it may be advantageous to use materials that have high corrosion resistance. For example, high density polyethylene (HDPE) may be particularly advantageous for providing high strength, low weight and good corrosion resistance. In addition, the HDPE (or other plastic, metal, etc.) may be treated/molded with compounds that prevent/limit degradation due to UV exposure. In addition, additives or surface treatments may be included that improve mechanical performance across a broader range of temperatures. Thus, the storage system 1 may have a long useful service life, and may be rated for carrying heavy loads suitable for the truck bed alone without adding excessive weight that may adversely affect the performance of the vehicle.

The long version of the truck storage system 1 corresponds to long truck bed designs of approximately 6.5 feet, and the short version of the truck storage system 1 corresponds to short truck bed designs of approximately 5.5 feet. In addition, the truck storage system 1 can support approximately 2000 lbs of load on its deck 10.

Although the present invention has been described with reference to particular examples and exemplary embodiments, it should be understood that the foregoing description is in no manner limiting. Moreover, the features described herein may be used in any combination.

What is claimed is:

1. A truck storage system, comprising:
a deck configured to span substantially a total width of a truck bed;
four support feet, each support foot situated at a respective corner of the truck bed and configured to support the deck;
a center support extending in a longitudinal direction of the truck bed between the support feet and configured to support the deck;
at least one drawer assembly situated between a front support foot of the four support feet and a rear support foot of the four support feet on a first side, and the center support on a second side, the drawer assembly configured to be slidable in the longitudinal direction of the truck bed; and
at least one storage compartment situated between the at least one drawer assembly and a side of the truck bed, wherein the at least one storage compartment is structurally separate from the support feet.

2. The system of claim 1, wherein the at least one storage compartment is at least substantially waterproof.

3. The system of claim 1, wherein the at least one storage compartment includes at least two storage compartments, wherein a first of the two storage compartments is situated adjacent the rear support foot and a second of the two storage compartments is situated adjacent the front support foot on the first side of the deck.

4. The system of claim 1, wherein the at least one storage compartment is fully removable.

5. The system of claim 1, further comprising:
at least one storage cover to cover the at least one storage compartment, wherein the at least one storage cover is approximately twice a length of a respective storage compartment.

6. The system of claim 1, further comprising:
at least two tie down attachment members, each tie down attachment member situated between the at least one drawer assembly and the side of the truck bed.

7. The system of claim 6, further comprising:
at least two brackets, each bracket connecting a respective tie down attachment member to a channel extending in a longitudinal direction of the truck bed,
wherein each of the brackets is configured to support a load on the deck, anchor cargo in place, and attach the storage system to the truck bed.

8. The system of claim 7, wherein the storage system is attached to the truck bed via a turnbuckle mechanism.

9. The system of claim 6, wherein each of the at least two tie down attachment members include an attachment ring configured to fold down into a recessed cavity of the deck and to rotate upward and swivel.

10. The system of claim 1, wherein the at least one drawer assembly includes at least two drawer assemblies that are nestable for packaging, shipping and/or storage.

11. The system of claim 1, wherein the at least one drawer assembly has side walls that slope at an angle of at most 1 degree.

12. The system of claim 1, wherein the at least one drawer assembly is configured to extend outward of the deck by at least 75% of a length of the at least one drawer assembly.

13. The system of claim 1, wherein an upper surface of the deck has a raised pattern configured to engage a relief pattern on an underside of at least one accessory case to thereby create a positive-fit connection between the deck and the at least one accessory case.

14. The system of claim 13, wherein the raised pattern covers a majority of the upper surface of the deck.

15. The system of claim 13, further comprising:
at least two tie down attachment members, each tie down attachment member situated between the at least one drawer assembly and the side of the truck bed, wherein an area between the at least two tie down attachment members does not contain the raised pattern.

16. The system of claim 1, wherein the deck includes two deck halves configured to interleave with each other above the center support.

17. The system of claim 1, wherein the front support foot and the rear support foot are dimensionally different.

18. The system of claim 1, further comprising:
at least one closeout member which is configured to provide stability to the deck and to prevent an ingress of water into the at least one drawer assembly.

19. A truck storage system, comprising:
a deck configured to span substantially a total width of a truck bed;
four support feet, each support foot situated at a respective corner of the truck bed and configured to support the deck;
a center support extending in a longitudinal direction of the truck bed between the support feet and configured to support the deck;
at least one drawer assembly situated between a) a front support foot and a rear support foot on one side, and b) the center support on an other side, the drawer assembly configured to be slidable in the longitudinal direction of the truck bed; and
at least one storage compartment, the at least one storage compartment situated between the at least one drawer assembly and a side of the truck bed, wherein the at least one storage compartment is situated adjacent to a respective rear support foot.

20. A truck storage system, comprising:
a deck configured to span substantially a total width of a truck bed;
four support feet, each support foot situated at a respective corner of the truck bed and configured to support the deck;
a center support extending in a longitudinal direction of the truck bed between the support feet and configured to support the deck;
at least one drawer assembly situated between a) a front support foot and a rear support foot on one side, and b) the center support on an other side, the drawer assembly configured to be slidable in the longitudinal direction of the truck bed;
at least one storage compartment, the at least one storage compartment situated between the at least one drawer assembly and a side of the truck bed, wherein the at least one storage compartment is structurally separate from the support feet;
at least one tie down attachment member, the tie down attachment member situated between the at least one drawer assembly and the side of the truck bed; and
at least one bracket, wherein the at least one bracket connects the tie down attachment member to a channel extending in a longitudinal direction of the truck bed.
